(19) United States
(12) Patent Application Publication
(10) Pub. No.: US 2024/0111169 A1
(43) Pub. Date: Apr. 4, 2024

(54) Electronic Device with a Lens Module

(71) Applicant: Apple Inc., Cupertino, CA (US)

(72) Inventors: Ran He, Cupertino, CA (US); Francois R. Jacob, Sunnyvale, CA (US); Zachary A. Granger, Redwood City, CA (US); Brent J. Bollman, Alameda, CA (US)

(21) Appl. No.: 18/541,279

(22) Filed: Dec. 15, 2023

Related U.S. Application Data
(63) Continuation of application No. PCT/US2022/035174, filed on Jun. 27, 2022.
(60) Provisional application No. 63/217,987, filed on Jul. 2, 2021.

(51) Int. Cl. G02B 27/28; G02B 5/30

(52) U.S. Cl. CPC G02B 27/286; G02B 5/3016; G02B 3/0087

(57) ABSTRACT

A head-mounted display may include a display system and an optical system that are supported by a housing. The optical system may be a catadioptric optical system having one or more lens elements. The optical system may include a quarter wave plate that is coated to the first lens element without an intervening adhesive layer. The optical system may further include a reflective polarizer and a linear polarizer. The linear polarizer may be formed as a coating directly on the reflective polarizer (without an intervening adhesive). A single circular reflective polarizer may be used instead of a quarter wave plate and a reflective polarizer. The circular reflective polarizer may be coated to the first lens element without an intervening adhesive layer. The circular reflective polarizer may optionally provide optical power to the lens module. The circular reflective polarizer may include a cholesteric liquid crystal layer.

This application is a continuation of international patent application No. PCT/US22/35174, filed Jun. 27, 2022, which claims priority to U.S. provisional patent application No. 63/217,987, filed Jul. 2, 2021, which are hereby incorporated by reference herein in their entireties.

### BACKGROUND

This relates generally to optical systems and, more particularly, to optical systems for head-mounted displays.

Head-mounted displays such as virtual reality glasses use lenses to display images for a user. A microdisplay may create images for each of a user's eyes. A lens may be placed between each of the user's eyes and a portion of the microdisplay so that the user may view virtual reality content.

If care is not taken, a head-mounted display may be cumbersome and tiring to wear. Optical systems for head-mounted displays may use arrangements of lenses that are bulky and heavy. Extended use of a head-mounted display with this type of optical system may be uncomfortable.

It would therefore be desirable to be able to provide improved head-mounted displays.

### SUMMARY

A head-mounted display may include a display system and an optical system. The display system and optical system may be supported by a housing that is worn on a user's head. The head-mounted display may use the display system and optical system to present images to the user while the housing is being worn on the user's head.

The display system may have a pixel array that produces image light associated with the images. The display system may also have a linear polarizer through which image light from the pixel array passes and a quarter wave plate through which the light passes after passing through the linear polarizer.

The optical system may be a catadioptric optical system having at least first and second lens elements. The optical system may include a quarter wave plate that is coated to the first lens element without an intervening adhesive layer. The optical system may further include a reflective polarizer and a linear polarizer. The linear polarizer may be formed as a coating directly on the reflective polarizer (without an intervening adhesive).

In another possible arrangement, a single circular reflective polarizer may be used instead of a quarter wave plate and a reflective polarizer. The circular reflective polarizer may be coated to the first lens element without an intervening adhesive layer. The circular reflective polarizer may optionally provide optical power to the lens module. The circular reflective polarizer may include a cholesteric liquid crystal layer.

An additional lens element may be included in the lens module, with a partially reflective layer interposed between two of the three lens elements in the lens module. The additional lens element may conform to the partially reflective layer or may be attached directly to the display system.

### BRIEF DESCRIPTION OF THE DRAWINGS

FIG. 1 is a diagram of an illustrative head-mounted display in accordance with an embodiment.

FIG. 2 is a diagram of an illustrative head-mounted display showing components of an illustrative optical system in the head-mounted display in accordance with an embodiment.

FIG. 3 is a cross-sectional side view of an illustrative head-mounted display showing how the polarization of light changes when passing through the optical system of FIG. 2 in accordance with an embodiment.

FIG. 4 is a diagram of an illustrative head-mounted display showing an optical system that includes a coatable polarizer in accordance with an embodiment.

FIG. 5 is a diagram of an illustrative head-mounted display showing an optical system that includes a reflective polarizer and retarder layer in accordance with an embodiment.

FIG. 6 is a cross-sectional side view of an illustrative head-mounted display showing how the polarization of light changes when passing through the optical system of FIG. 5 in accordance with an embodiment.

FIG. 7 is a diagram of an illustrative head-mounted display showing an optical system with a reflective polarizer and retarder layer that provides optical power in accordance with an embodiment.

FIG. 8A is a cross-sectional side view of an illustrative reflective polarizer and retarder layer that is formed from a cholesteric liquid crystal layer in accordance with an embodiment.

FIG. 8B is a cross-sectional side view of an illustrative reflective polarizer and retarder layer that is formed from a liquid crystal geometric phase layer in accordance with an embodiment.

FIG. 9 is a diagram of an illustrative head-mounted display showing an optical system that includes a lens element with an embedded gap and a functional layer in the gap in accordance with an embodiment.

FIGS. 10A and 10B are cross-sectional side and top views, respectively, of an illustrative lens element having a refractive index gradient in accordance with an embodiment.

FIG. 11 is a cross-sectional side view of an illustrative lens element having an embedded air gap with a non-uniform thickness in accordance with an embodiment.

FIG. 12 is a cross-sectional side view of an illustrative lens element having multiple embedded material-filled gaps distributed between the front and rear of the lens element in accordance with an embodiment.

FIG. 13 is a cross-sectional side view of an illustrative lens element having multiple embedded material-filled gaps distributed within the plane of the lens element in accordance with an embodiment.

FIG. 14 is a cross-sectional side view of an illustrative lens element having an embedded air gap that includes a half-mirror in accordance with an embodiment.

FIG. 15 is a diagram of an illustrative head-mounted display showing an optical system that includes a half-mirror between first and second lens elements in accordance with an embodiment.

FIG. 16 is a diagram of an illustrative head-mounted display with a lens element that is laminated to the display system in accordance with an embodiment.

FIG. 17 is a diagram of an illustrative head-mounted display with an optical system and a curved display system in accordance with an embodiment.

### DETAILED DESCRIPTION

Head-mounted displays may be used for virtual reality and augmented reality systems. For example, a pair of virtual reality glasses that is worn on the head of a user may be used to provide a user with virtual reality content and/or augmented reality content.

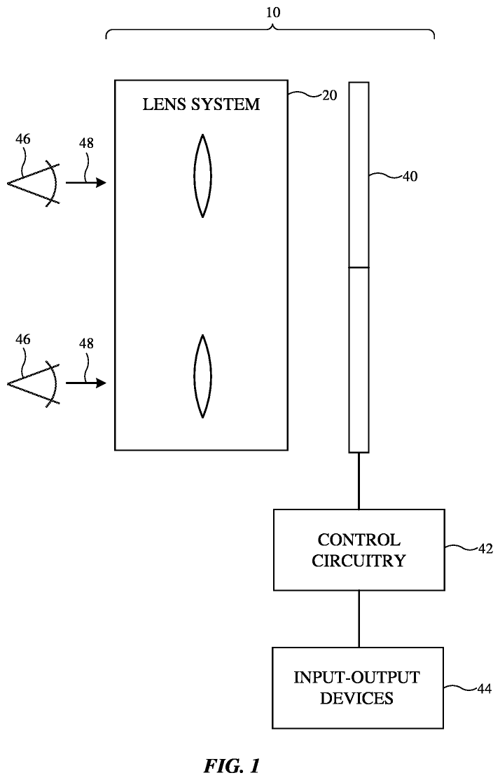

An illustrative system in which an electronic device (e.g., a head-mounted display such as a pair of virtual reality glasses) is used in providing a user with virtual reality content is shown in FIG. 1. As shown in FIG. 1, virtual reality glasses 10 (sometimes referred to as glasses 10, electronic device 10, head-mounted display 10, device 10, etc.) may include a display system such as display system 40 that creates images and may have an optical system such as optical system 20 through which a user (see, e.g., user's eyes 46) may view the images produced by display system 40 by looking in direction 48.

Display system 40 (sometimes referred to as display panel 40 or display 40) may be based on a liquid crystal display, an organic light-emitting diode display, an emissive display having an array of crystalline semiconductor light-emitting diode dies, and/or displays based on other display technologies. Separate left and right displays may be included in system 40 for the user's left and right eyes or a single display may span both eyes.

Visual content (e.g., image data for still and/or moving images) may be provided to display system (display) 40 using control circuitry 42 that is mounted in glasses (head-mounted display) 10 and/or control circuitry that is mounted outside of glasses 10 (e.g., in an associated portable electronic device, laptop computer, or other computing equipment). Control circuitry 42 may include storage such as hard-disk storage, volatile and non-volatile memory, electrically programmable storage for forming a solid-state drive, and other memory. Control circuitry 42 may also include one or more microprocessors, microcontrollers, digital signal processors, graphics processors, baseband processors, application-specific integrated circuits, and other processing circuitry. Communications circuits in circuitry 42 may be used to transmit and receive data (e.g., wirelessly and/or over wired paths). Control circuitry 42 may use display system 40 to display visual content such as virtual reality content (e.g., computer-generated content associated with a virtual world), pre-recorded video for a movie or other media, or other images. Illustrative configurations in which control circuitry 42 provides a user with virtual reality content using display system 40 may sometimes be described herein as an example. In general, however, any suitable content may be presented to a user by control circuitry 42 using display system 40 and optical system 20 of glasses 10.

Input-output devices 44 may be coupled to control circuitry 42. Input-output devices 44 may be used to gather user input from a user, may be used to make measurements on the environment surrounding glasses 10, may be used to provide output to a user, and/or may be used to supply output to external electronic equipment. Input-output devices 44 may include buttons, joysticks, keypads, keyboard keys, touch sensors, track pads, displays, touch screen displays, microphones, speakers, light-emitting diodes for providing a user with visual output, sensors (e.g., a force sensors, temperature sensors, magnetic sensor, accelerometers, gyroscopes, and/or other sensors for measuring orientation, position, and/or movement of glasses 10, proximity sensors, capacitive touch sensors, strain gauges, gas sensors, pressure sensors, ambient light sensors, and/or other sensors). If desired, input-output devices 44 may include one or more cameras/optical sensors (e.g., cameras for capturing images of the user's surroundings, cameras for performing gaze detection operations by viewing eyes 46, and/or other cameras).

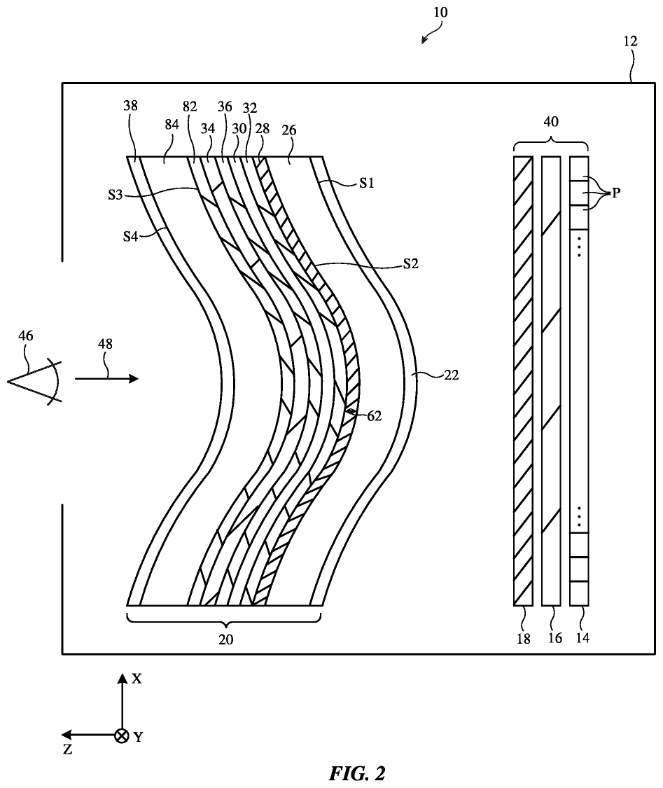

FIG. 2 is a cross-sectional side view of glasses 10 showing how optical system 20 and display system 40 may be supported by head-mounted support structures such as housing 12 for glasses 10. Housing 12 may have the shape of a frame for a pair of glasses (e.g., glasses 10 may resemble eyeglasses), may have the shape of a helmet (e.g., glasses 10 may form a helmet-mounted display), may have the shape of a pair of goggles, or may have any other suitable housing shape that allows housing 12 to be worn on the head of a user. Configurations in which housing 12 supports optical system 20 and display system 40 in front of a user's eyes (e.g., eyes 46) as the user is viewing system 20 and display system 40 in direction 48 may sometimes be described herein as an example. If desired, housing 12 may have other desired configurations.

Housing 12 may be formed from plastic, metal, fiber-composite materials such as carbon-fiber materials, wood and other natural materials, glass, other materials, and/or combinations of two or more of these materials.

Input-output devices 44 and control circuitry 42 may be mounted in housing 12 with optical system 20 and display system 40 and/or portions of input-output devices 44 and control circuitry 42 may be coupled to glasses 10 using a cable, wireless connection, or other signal paths.

Display system 40 and the optical components of glasses 10 may be configured to display images for user 46 using a lightweight and compact arrangement. Optical system 20 may, for example, be based on catadioptric lenses (e.g., lenses that use both reflecting and refracting of light).

Display system 40 may include a source of images such as pixel array 14. Pixel array 14 may include a two-dimensional array of pixels P that emits image light (e.g., organic light-emitting diode pixels, light-emitting diode pixels formed from semiconductor dies, liquid crystal display pixels with a backlight, liquid-crystal-on-silicon pixels with a frontlight, etc.). A polarizer such as linear polarizer 16 may be placed in front of pixel array 14 and/or may be laminated to pixel array 14 to provide polarized image light. Linear polarizer 16 may have a pass axis aligned with the X-axis of FIG. 2 (as an example). Display system 40 may also include a wave plate such as quarter wave plate 18 to provide circularly polarized image light. The fast axis of quarter wave plate 18 may be aligned at 45 degrees relative to the pass axis of linear polarizer 16. Quarter wave plate 18 may be mounted in front of polarizer 16 (between polarizer 16 and optical system 20). If desired, quarter wave plate 18 may be attached to polarizer 16 (and display 14).

Optical system 20 may include a lens element such as lens element 26. Lens element 26 may be formed from a transparent material such as plastic or glass. Lens element 26 may have a surface S1 that faces display system 40 and a surface S2 that faces the user (e.g. eyes 46). Surface S1 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface that includes both convex and concave portions. Herein, a freeform surface that is primarily convex may sometimes still be referred to as a convex surface and a freeform surface that is primarily concave may sometimes still be referred to as a concave surface. Surface S2 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface that includes both convex and concave portions. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In one illustrative arrangement, shown in FIG. 2, surface S1 is an aspheric convex surface and surface S2 is an aspheric concave surface. This arrangement may be described as an example herein.

Optical structures such as partially reflective coatings, wave plates, reflective polarizers, linear polarizers, antireflection coatings, and/or other optical components may be incorporated into glasses 10 (e.g., system 20, etc.). These optical structures may allow light rays from display system 40 to pass through and/or reflect from surfaces in optical system 20 such as surfaces S1 and S2, thereby providing optical system 20 with a desired lens power.

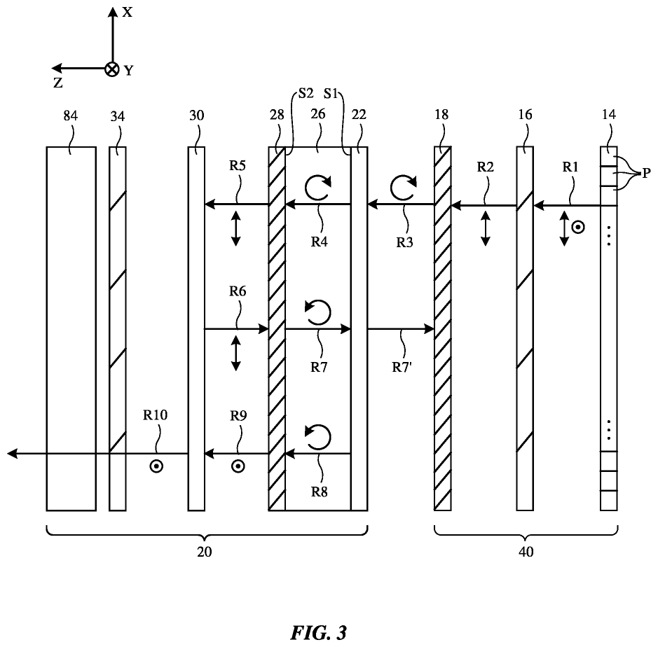

An illustrative arrangement for the optical layers is shown in FIG. 2. First, the structural arrangement of these layers will be described. The functionality of these layers will be discussed in more detail in connection with FIG. 3.

As shown in FIG. 2, a partially reflective mirror (e.g., a metal mirror coating or other mirror coating such as a dielectric multilayer coating with a 50% transmission and a 50% reflection) such as partially reflective mirror 22 may be formed on the aspheric convex surface S1 of lens element 26. Partially reflective mirror 22 may sometimes be referred to as beam splitter 22, half mirror 22, or partially reflective layer 22.

A wave plate such as wave plate 28 may be formed on the aspheric concave surface S2 of lens element 26. Wave plate 28 (sometimes referred to as retarder 28, quarter wave plate 28, etc.) may be a quarter wave plate that conforms to surface S2 of lens element 26. Retarder 28 may be a coating on surface S2 of lens element 26.

Reflective polarizer 30 may be attached to retarder 28 using adhesive layer 32. Reflective polarizer 30 may have orthogonal reflection and pass axes. Light that is polarized parallel to the reflection axis of reflective polarizer 30 will be reflected by reflective polarizer 30. Light that is polarized perpendicular to the reflection axis and therefore parallel to the pass axis of reflective polarizer 30 will pass through reflective polarizer 30. Adhesive layer 32 may be a layer of optically clear adhesive (OCA).

Polarizer 34 may be attached to reflective polarizer 30 using adhesive layer 36. Polarizer 34 may be a linear polarizer. Polarizer 34 may be referred to as an external blocking linear polarizer 34 or cleanup polarizer 34. Linear polarizer 34 may have a pass axis aligned with the pass axis of reflective polarizer 30. Linear polarizer 34 may have a pass axis that is orthogonal to the pass axis of linear polarizer 16. Adhesive layer 36 may be a layer of optically clear adhesive (OCA).

Optical system 20 may include an additional lens element such as lens element 84. Lens element 84 may be formed from a transparent material such as plastic or glass. Lens element 84 may have a surface S3 that faces display system 40 and a surface S4 that faces the user (e.g. eyes 46). Surface S3 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface that includes both convex and concave portions. Surface S4 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface that includes both convex and concave portions. Lens element 84 may be attached to polarizer 34 using adhesive layer 82. Adhesive layer 82 may be a layer of optically clear adhesive (OCA).

One or more additional coatings 38 may also be included in optical system 20 (sometimes referred to as lens 20, lens assembly 20, or lens module 20). Coatings 38 may include an anti-reflective coating (ARC), anti-smudge (AS) coating, or any other desired coatings. In the example of FIG. 2, coatings 38 are formed on surface S4 of lens element 84.

FIG. 3 is a cross-sectional side view of an illustrative optical system 20 and display system 40 showing how light from the display passes through the optical system of FIG. 2. Note that the adhesive layers 32, 36, and 82 as well as coatings 38 are not shown in FIG. 3 since these layers do not appreciably impact the polarization of light travelling through the system.

As shown in FIG. 3, a light ray R1 may be emitted from display 14. Light ray R1 exits display 14 having a mix of polarization states. As image light ray R1 exits display 14 and passes through linear polarizer 16, ray R1 becomes linearly polarized in alignment with the pass axis of linear polarizer 16. The pass axis of linear polarizer 16 may be, for example, aligned with the X-axis of FIG. 3. After passing through polarizer 16, ray R2 passes through wave plate 18, which may be a quarter wave plate. As ray R2 passes through quarter wave plate 18, ray R3 exits the quarter wave plate circularly polarized (e.g., with a clockwise circular polarization).

When circularly polarized ray R3 strikes partially reflective mirror 22, a portion of ray R3 will pass through partially reflective mirror 22 to become reduced-intensity ray R4. Ray R4 will be refracted (partially focused) by the shape of aspheric convex surface S1 of lens element 26. It should be noted that the depiction of surfaces of S1 and S2 as planar in FIG. 3 is merely illustrative. In practice, surfaces S1 and S2 may be curved (e.g., aspheric convex and aspheric concave) as discussed in connection with FIG. 2.

Wave plate 28 may convert the circular polarization of ray R4 into linear polarization. Quarter wave plate 28 may, for example, convert circularly polarized ray R4 into a ray R5 with a linear polarization aligned with the X-axis of FIG. 2. Quarter wave plate 28 in optical system 20 may be rotated 90 degrees relative to quarter wave plate 18 in display 40 (e.g., the fast axes of quarter wave plates 18 and 28 are orthogonal).

As previously mentioned, reflective polarizer 30 may have orthogonal reflection and pass axes. Light that is polarized parallel to the reflection axis of reflective polarizer 30 will be reflected by reflective polarizer 30. Light that is polarized perpendicular to the reflection axis and therefore parallel to the pass axis of reflective polarizer 30 will pass through reflective polarizer 30. In the illustrative arrangement of FIG. 3, reflective polarizer 30 has a reflection axis that is aligned with the X-axis and a pass axis that is aligned with the Y-axis, so ray R5 will reflect from reflective polarizer 30 as reflected ray R6. It should be noted that the pass axis of reflective polarizer 30 is orthogonal to the pass axis of linear polarizer 16 in display system 40.

Reflected ray R6 has a linear polarization aligned with the X-axis. After passing through quarter wave plate 28, the linear polarization of ray R6 will be converted into circular polarization (i.e., ray R6 will become counter-clockwise circularly polarized ray R7).

Circularly polarized ray R7 will travel through lens element 26 and a portion of ray R7 will be reflected in the positive Z direction by the partially reflective mirror 22 on the convex surface S1 of lens element 26 as reflected ray R8. The reflection from the curved shape of surface S1 provides optical system 20 with additional optical power. It should be noted that any portion of ray R7 that is transmitted by the partially reflective layer 22 (e.g., R7′ in the negative Z-direction) may be converted to a linear polarization by quarter wave plate 18 and then reaches linear polarizer 16. This linearly polarized light has a polarization aligned with the Y-axis (e.g., orthogonal to the pass axis of linear polarizer 16) so that it is absorbed by linear polarizer 16. As a result, contrast degradation and stray light artifacts from this portion of R7 are prevented in the image viewed by the user.

Ray R8 from partially reflective mirror 22 is converted from circularly polarized light to linearly polarized light ray R9 by quarter wave plate 28. Passing through the curved surface S2 of lens element 26 also provides optical system 20 with additional optical power (e.g., refractive optical power). The linear polarization of ray R9 is aligned with the Y-axis, which is parallel to the pass axis of reflective polarizer 30. Accordingly, ray R9 will pass through reflective polarizer 30 as ray R10 to provide a viewable image to the user.

Linear polarizer 34 has a pass axis aligned with the pass axis of reflective polarizer 30 (i.e., parallel to the Y-axis in this example) so that any light from the external environment will be polarized by linear polarizer 34 such that light is not reflected by the reflective polarizer 30. Any light that is transmitted by the linear polarizer 34 and the reflective polarizer 30 will pass through retarders 28 and 18 and be absorbed by linear polarizer 16. Linear polarizer 34 has a pass axis (parallel to the Y-axis) that is orthogonal to the pass axis (parallel to the X-axis) of linear polarizer 16 in the display.

After passing through linear polarizer 34, the light finally passes through lens element 84. Lens element 84 provides optical system 20 with additional optical power (e.g., refractive optical power).

The optical system 20 may be formed as a single, solid lens assembly without any intervening air gaps. As shown in FIG. 2, each layer in optical system 20 is attached directly to the adjacent layers. This is particularly noteworthy for the case of retarder 28 being attached directly to the aspheric concave surface S2 of lens element 26.

Conventionally, retarders are planar. However, herein, retarder 28 is a coating that is applied directly on the curved surface of lens element 26 to provide uniform retardation across the lens element. Thereby, retarder 28 in FIG. 2 may have aspheric curvature (e.g., curvature along multiple axes and with different radii of curvature) with a relatively uniform thickness to provide a relatively uniform retardation. Retardation is equal to the thickness of the retarder multiplied by the birefringence of the retarder material. The thickness 62 (shown in FIG. 2) of retarder 28 may be relatively uniform across the optical system (lens assembly). Retarder 28 conforms to the three-dimensional surface of lens element 26 and may sometimes be referred to as a coating (e.g., coating 28 or retarder coating 28).

As specific examples, the retardation provided by retarder 28 across the entire retarder may be uniform within 20%, within 10%, within 5%, within 3%, within 2%, within 1%, etc. Similarly, the thickness 62 of retarder 28 across the entire retarder may be uniform within 20%, within 10%, within 5%, within 3%, within 2%, within 1%, etc. In other words, the retardation variation across the retarder is no more than 20%, no more than 10%, no more than 5%, no more than 3%, no more than 2%, no more than 1%, etc. The thickness variation across the retarder is no more than 20%, no more than 10%, no more than 5%, no more than 3%, no more than 2%, no more than 1%, etc.

Retarder 28 may be formed from any desired materials using any desired processes. As one example, retarder 28 may be formed from a liquid crystal material that is deposited over a photo-aligned alignment layer. As another example, retarder 28 may be formed from a liquid crystal material that is aligned using shear alignment. As yet another example, retarder 28 may be formed from an inorganic material using oblique deposition. The materials for retarder 28 may be deposited using spin coating, spray coating, physical vapor deposition (PVD), or any other desired techniques.

The example of a material having a uniform birefringence and relatively uniform birefringence being used to form the retarder is merely illustrative. Any type of retarder that provides uniform retardation may be used. As one example, the retarder may have a first thickness and a first birefringence in a first portion. The retarder may have a second thickness and a second birefringence in a second portion. The second birefringence may be different than the first birefringence and the second thickness may be different than the first thickness. However, the retardation may be the same in both portions. In other words, the retarder may be provided with different birefringence in different portions that are compensated by different thicknesses in the different portions to provide uniform retardation. These types of techniques may be used to provide uniform retardation even when uniform thickness is not practical from a manufacturing standpoint.

In the example of FIG. 2, reflective polarizer 30 and linear polarizer 34 are formed by optical films that are laminated to the lens assembly using optically clear adhesive. This type of arrangement may be satisfactory for some lens elements 26. Specifically, if the radius of curvature of lens element 26 (and lens element 84) is sufficiently large, reflective polarizer 30 and linear polarizer 34 may be formed using films. However, as the radius of curvature decreases (i.e., the curvature of the lens becomes greater), reflective polarizer 30 and linear polarizer 34 may experience reliability issues (e.g., wrinkling, cracking, etc.) due to the high levels of curvature required. Certain applications may require an optical system to include lens elements with high degrees of curvature. In these applications, it may be desirable to form reflective polarizer 30 and/or linear polarizer 34 as coatings (instead of as films laminated with adhesive).

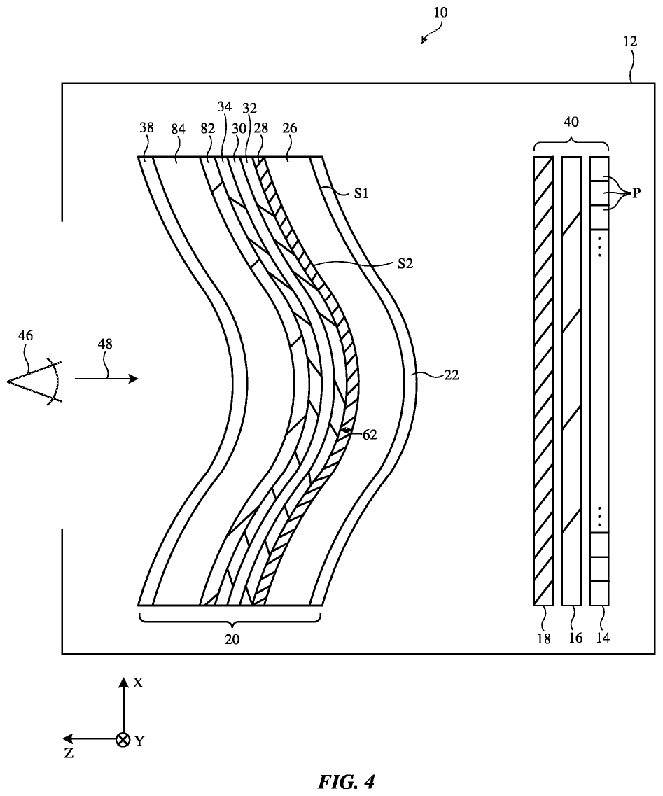

FIG. 4 is a cross-sectional side view of an illustrative device 10 having an optical system 20 that includes a linear polarizer coating. As shown in FIG. 4, the relative positions of the functional layers in optical system 20 are the same in FIG. 4 as previously shown in FIG. 2. However, linear polarizer 34 is formed as a coating directly on reflective polarizer 30. Consequently, the adhesive layer between reflective polarizer 30 and linear polarizer 34 may be omitted.

Coatable linear polarizer 34 in FIG. 4 may be formed from a layer of liquid crystal polymer or any other desired material that may be used to form a coating. The linear polarizer coating may include dichroic dye in addition to the base material (e.g., liquid crystal polymer). Forming linear polarizer 34 as a coating allows for more aggressive curvature of the lens elements (and their conformal layers) in optical system 20 without negatively impacting reliability.

The thickness of linear polarizer 34 across the entire polarizer may be uniform within 20%, within 10%, within 5%, within 3%, within 2%, within 1%, etc. The thickness variation across the linear polarizer may be no more than 20%, no more than 10%, no more than 5%, no more than 3%, no more than 2%, no more than 1%, etc.

FIG. 5 is a cross-sectional side view of an alternate design for optical system 20. Optical system 20 in FIG. 5 is similar to the optical system shown in connection with FIG. 4. Optical system 20 in FIG. 5 includes a lens element 26 having an aspheric convex surface S1 and an aspheric concave surface S2. On the side of lens element 26 facing eye 46, there is a linear polarizer 34, adhesive layer 82, lens element 84, and coatings 38. On the side of lens element 26 facing display 14, there is a partially reflective layer 22. These layers are all in the same relative positions as in FIG. 4.

However, in FIG. 4, there is a retarder 28 on surface S2 of lens element 26 and a separate reflective polarizer 30 that is coupled to retarder 28 using adhesive layer 32. In contrast, in FIG. 5 a single reflective polarizer and retarder layer 72 is used instead of a separately formed reflective polarizer and retarder. As shown in FIG. 5, reflective polarizer and retarder layer 72 (sometimes referred to as circular reflective polarizer 72) is coated directly on surface S2 of lens element 26. Reflective polarizer and retarder layer 72 may reflect light having a first circular polarization type and may transmit light having a second, opposite circular polarization type.

Reflective polarizer and retarder layer 72 may be formed from cholesteric liquid crystal or any other desired materials. The cholesteric liquid crystal layer 72 may be formed using three-dimensional (3D) coating and/or photoalignment techniques. The retardation provided by reflective polarizer and retarder layer 72 on transmitted light may be uniform across the reflective polarizer and retarder layer 72. As specific examples, the retardation provided by reflective polarizer and retarder layer 72 across the entire reflective polarizer and retarder layer may be uniform within 20%, within 10%, within 5%, within 3%, within 2%, within 1%, etc. Similarly, the thickness of reflective polarizer and retarder layer 72 across the entire reflective polarizer and retarder layer may be uniform within 20%, within 10%, within 5%, within 3%, within 2%, within 1%, etc. In other words, the retardation variation across the reflective polarizer and retarder layer is no more than 20%, no more than 10%, no more than 5%, no more than 3%, no more than 2%, no more than 1%, etc. The thickness variation across the reflective polarizer and retarder layer is no more than 20%, no more than 10%, no more than 5%, no more than 3%, no more than 2%, no more than 1%, etc.

As shown in FIG. 5, reflective polarizer and retarder layer 72 is coated on surface S2 of lens element 26 without an intervening adhesive layer. Additionally, similar to as discussed in connection with FIG. 4, linear polarizer 34 in FIG. 5 is coated directly on reflective polarizer and retarder layer 72 without an intervening adhesive layer.

It should be noted that, in FIG. 5 (e.g., when a reflective polarizer and retarder layer 72 is used), clean-up polarizer 34 may optionally be omitted entirely. In this case, adhesive 82 may be directly attached between reflective polarizer and retarder layer 72 on one side and lens element 84 on the other side. Alternatively, in embodiments with a reflective polarizer and retarder layer 72, clean-up polarizer 34 may not necessarily be a linear polarizer. For example, polarizer 34 may be a circular polarizer in FIG. 5.

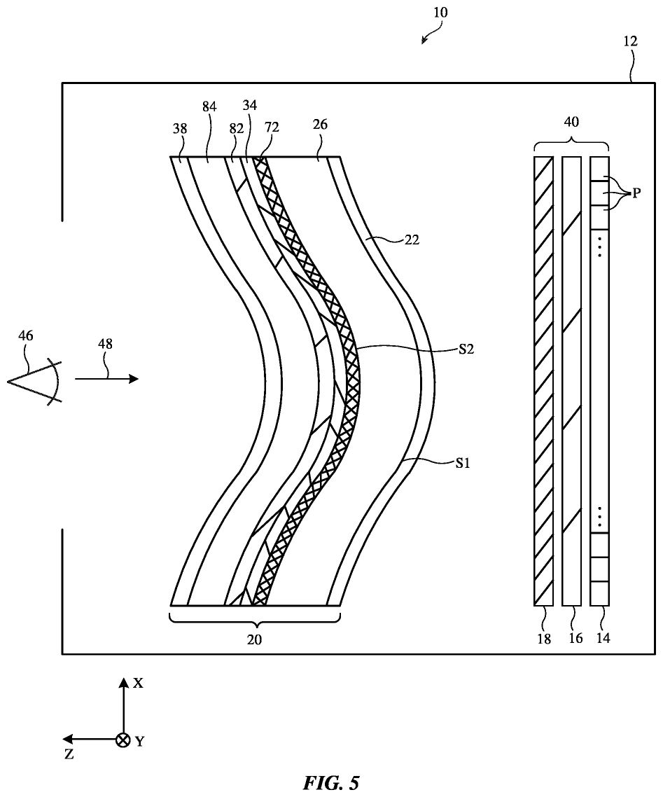

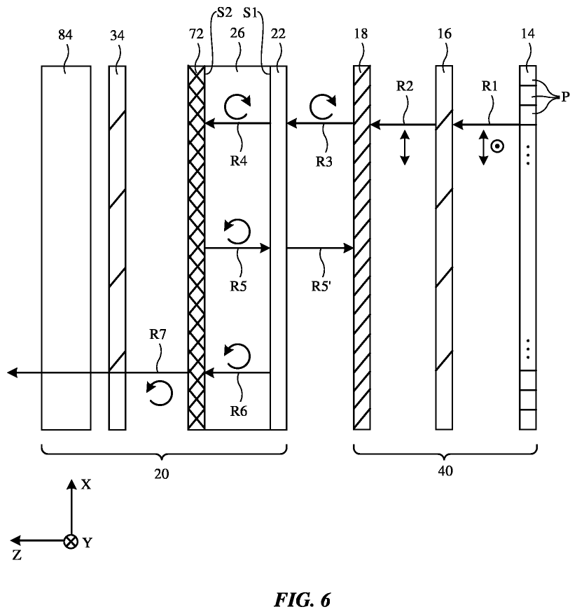

FIG. 6 is a cross-sectional side view of an illustrative optical system 20 and display system 40 showing how light from the display passes through the optical system of FIG. 5. Note that adhesive layer 82 as well as coatings 38 are not shown in FIG. 6 since these layers do not appreciably impact the polarization of light travelling through the system. As shown in FIG. 6, a light ray R1 may be emitted from display 14. Light ray R1 exits display 14 having a mix of polarization states. As image light ray R1 exits display 14 and passes through linear polarizer 16, ray R1 becomes linearly polarized in alignment with the pass axis of linear polarizer 16. The pass axis of linear polarizer 16 may be, for example, aligned with the X-axis of FIG. 6. After passing through polarizer 16, ray R2 passes through wave plate 18, which may be a quarter wave plate. As ray R2 passes through quarter wave plate 18, ray R3 exits the quarter wave plate circularly polarized (e.g., with a clockwise circular polarization).

When circularly polarized ray R3 strikes partially reflective mirror 22, a portion of ray R3 will pass through partially reflective mirror 22 to become reduced-intensity ray R4. Ray R4 will be refracted (partially focused) by the shape of aspheric convex surface S1 of lens element 26. It should be noted that the depiction of surfaces of S1 and S2 as planar in FIG. 6 is merely illustrative. In practice, surfaces S1 and S2 may be curved (e.g., aspheric) as discussed in connection with FIG. 2.

Circular reflective polarizer 72 may reflect light having clockwise circular polarization (a first circularly polarization) and may transmit light having counter-clockwise circular polarization (a second, opposite circular polarization). Accordingly, R4 is reflected by circular reflective polarizer 72. Reflected ray R5 passes through lens element 26 and a portion of ray R5 will be reflected in the positive Z direction by the partially reflective mirror 22 on the convex surface S1 of lens element 26 as reflected ray R6. The reflection from the curved shape of surface S1 provides optical system 20 with additional optical power. It should be noted that any portion of ray R5 that is transmitted by the partially reflective layer 22 (e.g., R5′ in the negative Z-direction) may be converted to a linear polarization by quarter wave plate 18 and then reaches linear polarizer 16. This linearly polarized light has a polarization aligned with the Y-axis (e.g., orthogonal to the pass axis of linear polarizer 16) so that it is absorbed by linear polarizer 16. As a result, contrast degradation and stray light artifacts from this portion of R5 are prevented in the image viewed by the user.

Ray R6 from partially reflective mirror 22 (having an opposite circular polarization as ray R4) is transmitted by circular reflective polarizer 72. Circular reflective polarizer 72 transmits counter-clockwise circularly polarized light. Passing through the curved surface S2 of lens element 26 also provides optical system 20 with additional optical power.

The light may pass through optional clean-up polarizer 34 then lens element 84 to reach the viewer. Lens element 84 provides optical system 20 with additional optical power (e.g., refractive optical power).

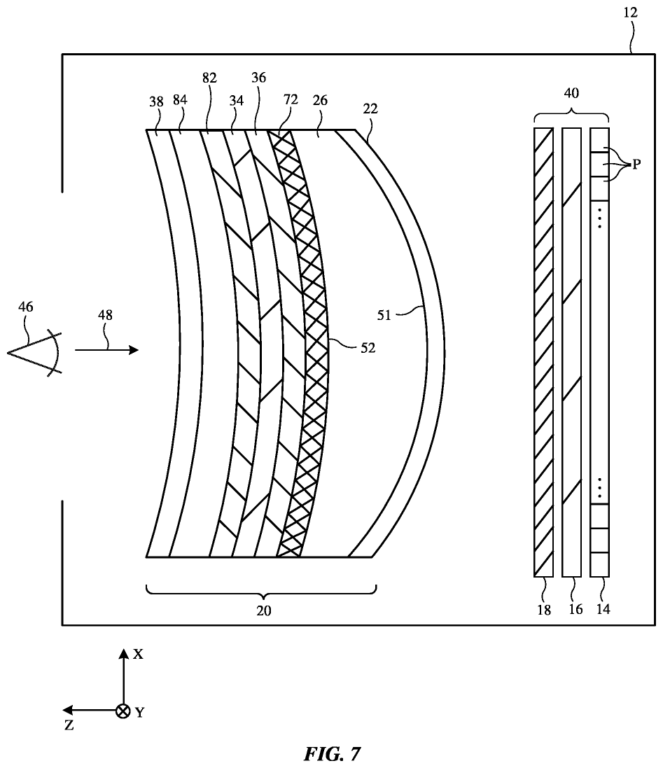

FIG. 7 is a cross-sectional side view of an illustrative device that includes an optical system with a circular reflective polarizer 72 that provides optical power. As shown in FIG. 7, similar to as in FIG. 5, circular reflective polarizer 72 is coated on surface S2 of lens element 26. However, the circular reflective polarizer 72 provides optical power to optical system 20. Accordingly, the curvature of lens element 26 in FIG. 7 may be reduced (relative to FIG. 5) while still achieving the same overall optical power as the more-curved lens element of FIG. 5. Because S2 has less curvature in FIG. 7 (than in FIG. 5), clean-up polarizer 34 may optionally be formed as a film (as in FIG. 2) instead of as a coating (as in FIG. 5). In FIG. 7, adhesive 36 is interposed between polarizer 34 and circular reflective polarizer 72. Lens element 84 is attached to polarizer 34 with adhesive 82.

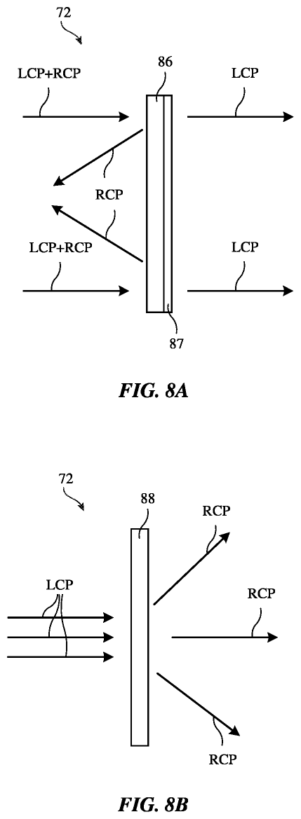

There are several ways to form reflective polarizer and retardation layer 72 such that reflective polarizer and retardation layer 72 provides optical power to the optical system. FIG. 8A is a cross-sectional side view of an illustrative reflective polarizer and retardation layer 72 that is formed using a coatable cholesteric liquid crystal layer 86. The cholesteric liquid crystal layer may be formed over a patterned alignment layer 87 that provides the cholesteric liquid crystal layer with desired focusing properties. As shown in FIG. 8A, a reflective polarizer and retardation layer 72 of this type may receive both right-hand and left-hand circularly polarized light. The left-hand circularly polarized light passes through the cholesteric liquid crystal layer 86 unchanged (e.g., the left-hand circularly polarized light is not focused or defocused by the cholesteric liquid crystal layer). The right-hand circularly polarized light is reflected off of the cholesteric liquid crystal layer 86 in a pattern that focuses the right-hand circularly polarized light. In this way, the cholesteric liquid crystal layer may selectively reflect and focus one type of circularly polarized light while transmitting (without focusing) an opposite type of circularly polarized light.

FIG. 8B is a cross-sectional side view of an illustrative reflective polarizer and retardation layer 72 that is formed using a liquid crystal geometric phase layer 88. To form the liquid crystal geometric phase layer 88, a liquid crystal film may be formed on a transparent substrate (e.g., glass, plastic, etc.). The liquid crystal film may include three-dimensional patterns of liquid crystals. The liquid crystals may manipulate the polarization of optical beams passing through the liquid crystals, which modulates the geometric phase of the optical beam. The geometric phase may be modulated in a spatially varying fashion to provide desired light redirecting effects. As shown in FIG. 8B, a reflective polarizer and retardation layer 72 of this type may receive left-hand circularly polarized light and output defocused (e.g., f<0) right-hand circularly polarized light. Conversely, a liquid crystal geometric phase layer may receive right-hand circularly polarized light and output focused (e.g., f>0) left-hand circularly polarized light.

A reflective polarizer and retardation layer 72 of the type shown in either FIG. 8A or FIG. 8B may be used in the optical system of FIG. 7.

FIG. 9 is a cross-sectional side view of another device that includes an optical system 20 with a lens element 26 having an embedded gap. As shown in FIG. 9, lens element 26 has a gap 26-3 embedded between a first lens element portion 26-1 and a second lens element portion 26-2. Lens element portions 26-1 and 26-2 may be formed from a transparent material such as plastic or glass. Lens element portion 26-1 has a first surface S1 adjacent to half-mirror 22 and a second surface S2 that partially defines gap 26-3. Lens element portion 26-2 has a first surface S3 that partially defines gap 26-3. Lens element portion 26-2 has a second surface S4 that is coated/laminated to other functional layers in the optical system.

As shown in FIG. 9, quarter wave plate 28 may be formed in gap 26-3. Quarter wave plate 28 may be formed by liquid quarter wave plate material that conforms to the volume of the embedded gap. With this type of arrangement, the gap (and embedded quarter wave plate) may have more aggressive curvature than when coated on an outer surface of lens element 26. In the arrangement of FIG. 9, reflective polarizer 30 is coated on surface S4 of lens element 26. In another possible arrangement, reflective polarizer 30 may be attached to surface S4 with adhesive. Adhesive 36 attaches reflective polarizer 30 to clean-up polarizer 34. The clean-up polarizer is in turn attached to lens element 84 using adhesive layer 82. Because of the gap 26-3 and embedded quarter wave plate, aggressive curvature may not be needed for surface S4 of lens element 26. This allows polarizer 34 to be formed as a film instead of a coating if desired.

The example in FIG. 9 of quarter wave plate 28 filling gap 26-3 is merely illustrative. In alternate arrangement, reflective polarizer and retardation layer 72 (e.g., liquid materials) may be formed in gap 26-3. In this arrangement, polarizer 34 may be coated or adhered to surface S4 without an intervening reflective polarizer 30.

In FIG. 9, gap 26-3 may have a uniform or near-uniform thickness. The thickness of gap 26-3 across the entire gap may be uniform within 20%, within 10%, within 5%, within 3%, within 2%, within 1%, etc. The thickness variation across the gap is no more than 20%, no more than 10%, no more than 5%, no more than 3%, no more than 2%, no more than 1%, etc.

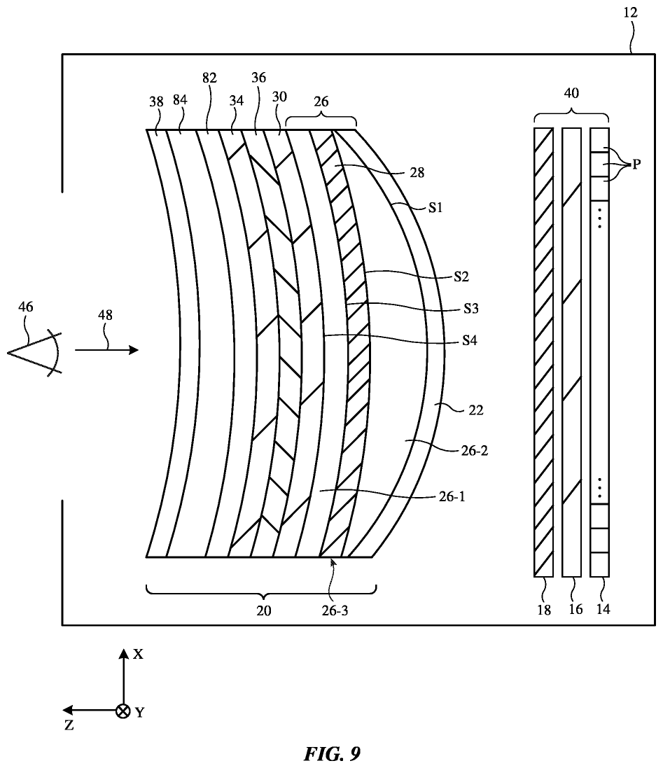

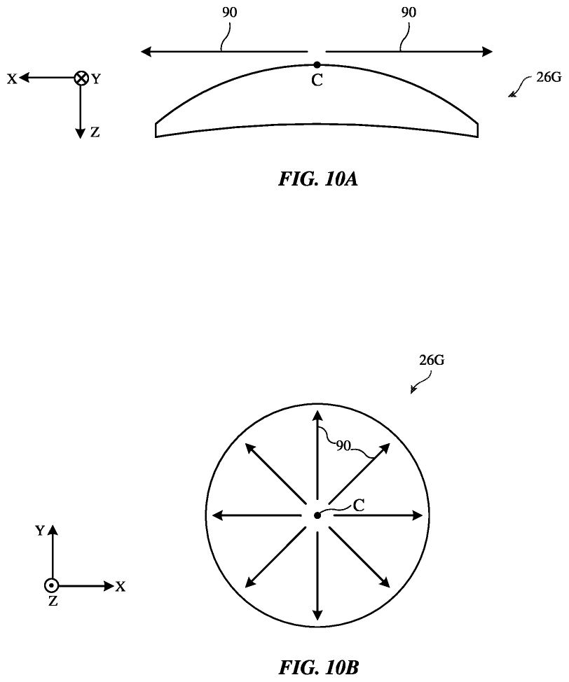

If desired, lens 26 may have a refractive index gradient. FIG. 10A is a cross-sectional side view of an illustrative lens 26G that has a refractive index gradient. Lens 26G may be used (as the lens element 26) in any of the optical assemblies described herein (e.g., FIGS. 2-7 and 9). The refractive index of lens 26G may change within the XY-plane from a center point C towards the edges of the lens element (as indicated by arrows 90). FIG. 10B is a top view of lens 26G showing how the refractive index may change gradually and radially from center C. In one possible arrangement, refractive index may be at a maximum magnitude at center C. The refractive index gradually decreases from center C towards the edges of the lens element (e.g., in a radial pattern indicated by arrows 90). This example is merely illustrative. In general, lens element 26G may have any desired refractive index gradient.

In one possible arrangement, the refractive index may be at a minimum magnitude at center C and gradually increases from center C towards the edges of the lens element (e.g., in a radial pattern). The refractive index may change gradually and monotonically or may have various local maxima and/or minima. The refractive index gradient may extend radially throughout the lens element, may extend in only one dimension across the lens element, etc. Additionally, the examples of FIGS. 10A and 10B show how the refractive index may vary in the X and Y directions. The refractive index may instead or in addition vary in the Z direction. For example, the refractive index may have a first gradient within the XY-plane and a second gradient in the Z-direction.

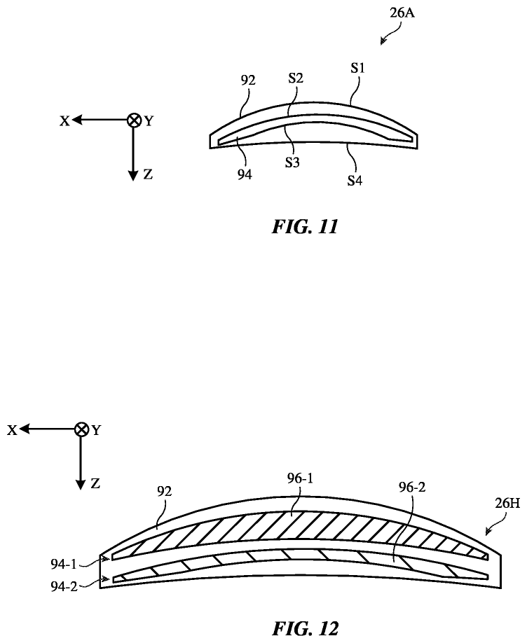

If desired, lens 26 may have an embedded air gap. FIG. 11 is a cross-sectional side view of an illustrative lens 26A that has an embedded air gap. Lens 26A may be used (as the lens element 26) in any of the optical assemblies described herein (e.g., FIGS. 2-7 and 9). As shown in FIG. 11, lens 26A has a solid portion 92 (e.g., formed from a transparent material such as plastic or glass). Lens 26A also includes an embedded air gap 94. Air gap 94 may be totally surrounded by solid portion 92.

Solid portion 92 includes a front surface S1 (e.g., that faces the display), a rear surface S4 (e.g., that faces the viewer), and surfaces S2 and S3 that define air gap 94. Surface S2 (at the front side of the lens element) may optionally have different curvature (e.g., a lower radius of curvature) than front surface S1 of solid portion 92. Surface S3 (at the rear side of the lens element) may optionally have different curvature (e.g., a lower radius of curvature) than rear surface S4 of solid portion 92.

Gap 94 may have a non-uniform thickness. The thickness variation across the gap may be more than 10%, more than 20%, more than 50%, more than 100%, etc.

Including an air gap as in FIG. 11 may allow for the curvature of surface S4 to be reduced, allowing for easier manufacturing and attachment to the other functional layers in the optical system.

If desired, lens 26 may include multiple embedded, filled gaps. FIG. 12 is a cross-sectional side view of an illustrative lens 26H that has embedded gaps filled with filler material. Lens 26H may be used (as the lens element 26) in any of the optical assemblies described herein (e.g., FIGS. 2-7 and 9). As shown in FIG. 12, lens 26H has a solid portion 92 (e.g., formed from a transparent material such as plastic or glass). Lens 26H also includes embedded gaps (sometimes referred to as voids) 94-1 and 94-2. Each one of gaps 94-1 and 94-2 may be totally surrounded by solid portion 92.

The surfaces that define the gaps may have the same curvature as the front/rear surfaces of the lens element or may have different curvature than the front/rear surfaces of the lens element. The surfaces that define the gaps may have the same curvature as each other or may have different curvature than each other.

Gap 94-1 may have a uniform or near uniform thickness (as described in connection with FIG. 9) or may have a non-uniform thickness (as described as in connection with FIG. 11). Gap 94-2 may have a uniform or near uniform thickness (as described in connection with FIG. 9) or may have a non-uniform thickness (as described as in connection with FIG. 11).

A respective filler material is formed in each one of the gaps. Filler material 96-1 is formed in gap 94-1. Filler material 96-2 is formed in gap 94-2. Filler materials 96-1 and 96-2 may have the same refractive indices or may have different refractive indices (e.g., differing by more than 0.05, more than 0.1, more than 0.2, more than 0.3, etc.). Filler materials 96-1 and 96-2 may be formed from liquid materials. Each filler material may have a different refractive index than solid portion 92 (e.g., differing by more than 0.05, more than 0.1, more than 0.2, more than 0.3, more than 0.5, etc.).

Including filled gaps as in FIG. 12 may allow for the curvature of the rear surface of the lens element to be reduced, allowing for easier manufacturing and attachment to the other functional layers in the optical system.

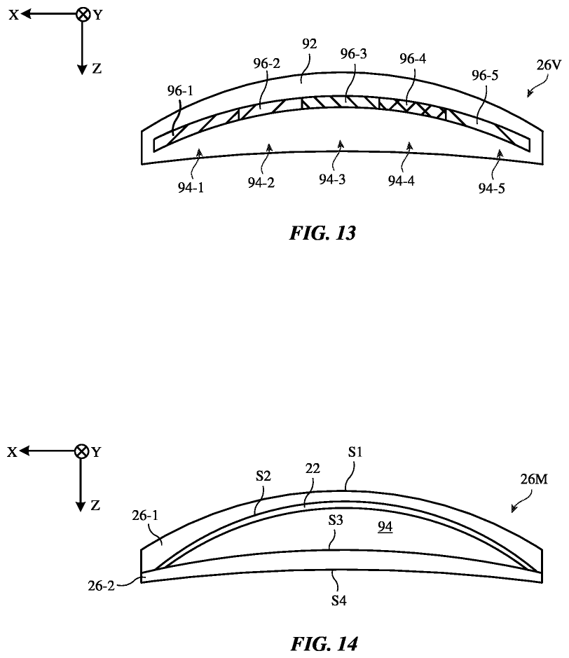

In FIG. 12, lens element 26H includes multiple filled gaps in the Z-direction. As an alternate arrangement, the lens element may include multiple filled gaps in the X-direction and/or Y-direction. FIG. 13 is a cross-sectional side view of an illustrative lens 26V that has embedded gaps filled with filler material. Lens 26V may be used (as the lens element 26) in any of the optical assemblies described herein (e.g., FIGS. 2-7 and 9). As shown in FIG. 13, lens 26V has a solid portion 92 (e.g., formed from a transparent material such as plastic or glass). Lens 26V also includes embedded gaps (sometimes referred to as voids) 94-1, 94-2, 94-3, 94-4, and 94-5. Dividing walls (sometimes referred to as support structures) may separate adjacent gaps. The dividing walls may be formed integrally with solid portion 92 (e.g., from the same material as solid portion 92) or may be formed from a different material than solid portion 92.

Each one of the gaps may have a uniform or near uniform thickness (as described in connection with FIG. 9) or may have a non-uniform thickness (as described as in connection with FIG. 11).

The surfaces that define the gaps may have the same curvature as the front/rear surfaces of the lens element or may have different curvature than the front/rear surfaces of the lens element. The surfaces that define the gaps may have the same curvature as each other or may have different curvature than each other.

A respective filler material is formed in each one of the gaps. Filler material 96-1 is formed in gap 94-1. Filler material 96-2 is formed in gap 94-2. Filler material 96-3 is formed in gap 94-3. Filler material 96-4 is formed in gap 94-4. Filler material 96-5 is formed in gap 94-5. Filler materials 96-1, 96-2, 96-3, 96-4, and 96-5 may have the same refractive indices or may have different refractive indices (e.g., differing by more than 0.05, more than 0.1, more than 0.2, more than 0.3, etc.). Filler materials 96-1, 96-2, 96-3, 96-4, and 96-5 may be formed from liquid materials. Each filler material may have a different refractive index than solid portion 92 (e.g., differing by more than 0.05, more than 0.1, more than 0.2, more than 0.3, more than 0.5, etc.).

Including filled gaps as in FIG. 13 may allow for the curvature of the rear surface of the lens element to be reduced, allowing for easier manufacturing and attachment to the other functional layers in the optical system.

In each one of FIGS. 10-13, lens element 26 is modified to achieve a target optical power magnitude without requiring high levels of curvature on the rear surface of the lens element.

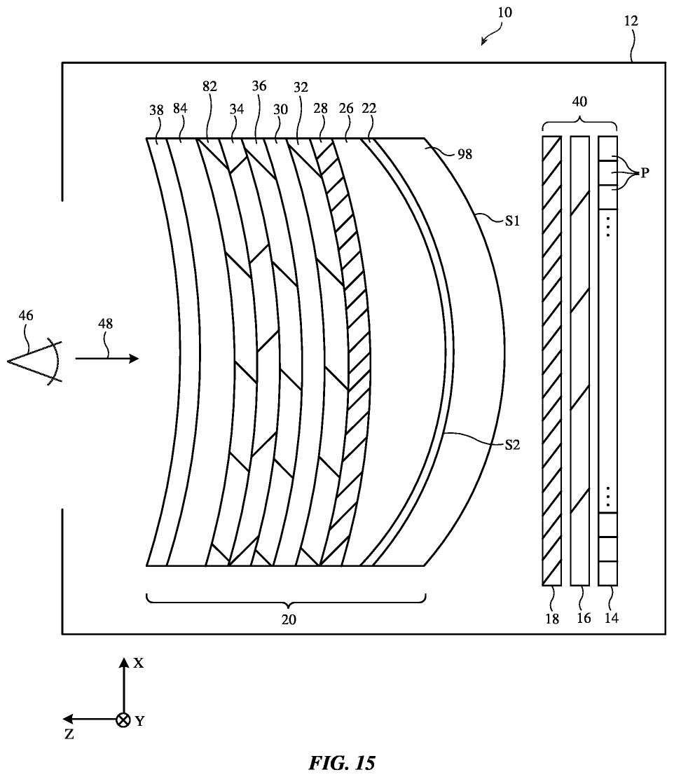

In another possible arrangement, shown in FIG. 14, lens 26 may have an embedded air gap that includes half-mirror 22. FIG. 14 is a cross-sectional side view of an illustrative lens 26M that has an embedded air gap and half-mirror 22. In the previous arrangements for lens element 26 and optical system 20 (e.g., in FIGS. 2-7 and 9-13), half-mirror 22 is formed on the front surface of lens element 26 (e.g., the surface of the lens element facing the display, as in FIG. 2). In FIG. 14, half-mirror 22 is instead embedded within lens element 26M.

As shown in FIG. lens element 26M includes a first portion 26-1 and a second portion 26-2. As a matter of nomenclature, it should be noted that lens element portions 26-1 and 26-2 may instead be referred to as lens elements 26-1 and 26-2. However, herein, the term portions will be used.

Portions 26-1 and 26-2 of lens element 26M may be formed from a solid, transparent material (e.g., plastic or glass). Portions 26-1 and 26-2 define an air gap 94. Air gap 94 may have a non-uniform thickness (as described in connection with FIG. 11). Lens element 26M includes a front surface S1 (e.g., that faces the display), a rear surface S4 (e.g., that faces the viewer), and surfaces S2 and S3 that define air gap 94. Surface S2 (at the front side of the lens element) may optionally have different curvature (e.g., a lower radius of curvature) than front surface S1 of solid portion 92. Surface S3 (at the rear side of the lens element) may optionally have different curvature (e.g., a lower radius of curvature) than rear surface S4 of solid portion 92. Half-mirror 22 is formed on surface S2 (e.g., the concave surface that defines void 94).

The arrangement of FIG. 14 may allow for the curvature of surface S4 to be reduced, allowing for easier manufacturing and attachment to the other functional layers in the optical system.

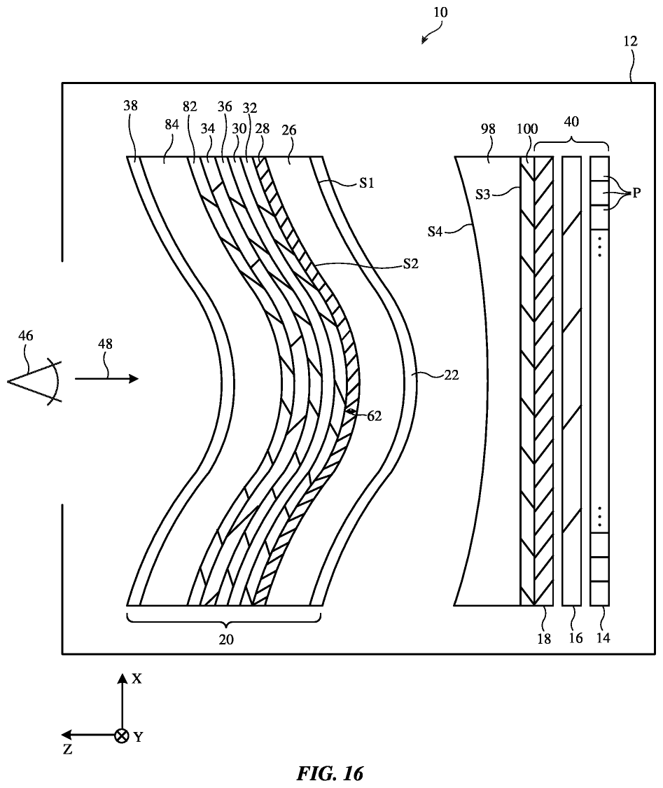

If desired, a third lens element may be included in the optical system 20 of device 10. FIG. 15 is a cross-sectional side view of a device that includes three lens elements. As shown in FIG. 15, the optical system may have the same arrangement as in FIG. 2 (with half-mirror coating 22 on one side of lens element 26 and quarter wave plate 28, reflective polarizer 34, lens element 84, and coatings 38 on the other side of lens element 26). However, in addition to lens elements 26 and 84, the optical system includes an additional lens element 98. As shown in FIG. 15, half-mirror 22 is interposed between lens element 26 and lens element 98.

Lens element 98 may be formed from a transparent material such as plastic or glass. Lens element 98 may have a surface S1 that faces display system 40 and a surface S2 that faces the user (e.g. eyes 46). Surface S1 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface that includes both convex and concave portions. Surface S2 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface that includes both convex and concave portions.

Including additional lens element 98 in the optical system may allow for less curvature of the rear surface of lens element 26 while achieving a target optical power. Other optical layers (e.g., the quarter wave plate, reflective polarizer, clean-up polarizer, etc.) may therefore be applied to the lens element 26 without reliability issues.

It should be noted that an additional lens element 98 as in FIG. 15 may be included for any of the optical assemblies described herein (e.g., an optical system that uses a single reflective polarizer and retarder layer 72 instead of a separately formed reflective polarizer 30 and retarder 28, an optical system that uses a coatable polarizer as in FIG. 4, an optical system with a lens element of the type shown in FIGS. 9-14, etc.).

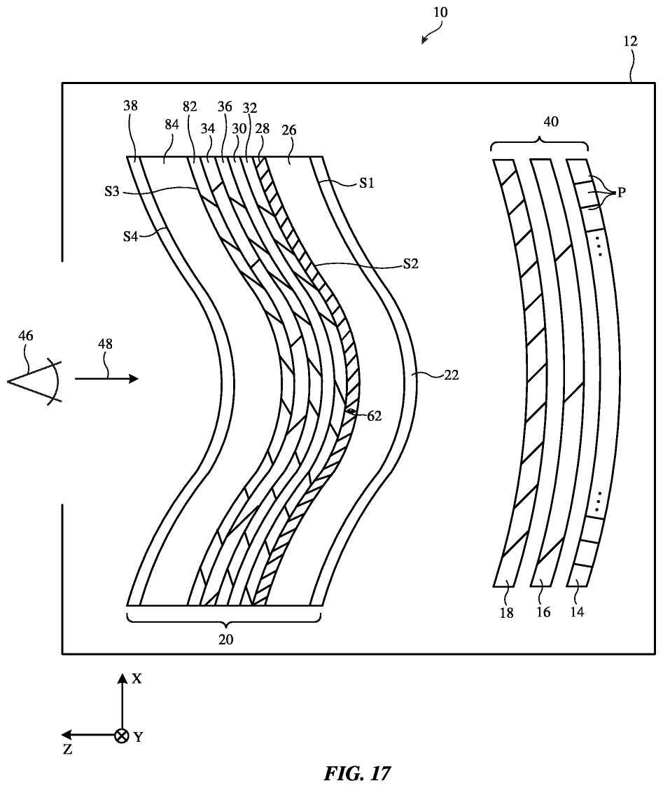

The example in FIG. 15 of lens element 98 being attached directly to half-mirror 22 is merely illustrative. If desired, a third lens element may be included in the device that is attached directly to display system 40. FIG. 16 is a cross-sectional side view of a device that includes a lens element that is laminated to the display system. As shown in FIG. 16, the optical system may have the same arrangement as in FIG. 2 (with half-mirror coating 22 on one side of lens element 26 and quarter wave plate 28, reflective polarizer 34, lens element 84, and coatings 38 on the other side of lens element 26). However, in addition to lens elements 26 and 84, the optical system includes an additional lens element 98. As shown in FIG. 16, half-mirror 22 is interposed between lens element 26 and lens element 98. Lens element 98 is laminated to display system 40 with adhesive layer 100. Adhesive layer 100 may be an optically clear adhesive (OCA) layer.

Lens element 98 in FIG. 16 may be formed from a transparent material such as plastic or glass. Lens element 98 may have a planar surface S3 that is laminated to display system 40 and a surface S4 that faces the user (e.g. eyes 46). Surface S4 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface that includes both convex and concave portions.

Including additional lens element 98 in the optical system may allow for less curvature of the rear surface of lens element 26 while achieving a target optical power. The optical layers (e.g., the quarter wave plate, reflective polarizer, clean-up polarizer, etc.) may therefore be applied to the lens element 26 without reliability issues. Laminating lens element 98 to display system 40 may also improve the heat dissipation from display system 40. Lens element 98 may be formed from a material having a high thermal conductivity to improve heat dissipation. The material used to form lens element 98 may have a thermal conductivity of greater than 0.1 W/mK, greater than 0.2 W/mK, greater than 0.3 W/mK, greater than 0.5 W/mK, greater than 0.8 W/mK, greater than 1 W/mK, etc.,

It should be noted that an additional lens element 98 as in FIG. 16 may be included for any of the devices described herein (e.g., an optical system that uses a single reflective polarizer and retarder layer 72 instead of a separately formed reflective polarizer 30 and retarder 28, an optical system that uses a coatable polarizer as in FIG. 4, an optical system with a lens element of the type shown in FIGS. 9-14, etc.).

To reduce the amount of lens curvature required in optical system 20, display system may be curved. FIG. 17 is a diagram of an illustrative head-mounted display having an optical system and a curved display. As shown, each one of quarter wave plate 18, linear polarizer 16, and pixel array 14 may be curved. Each one of quarter wave plate 18, linear polarizer 16, and pixel array 14 may have a concave surface that faces optical system 20. The components in display system 40 may be cylindrically concave, spherically concave, aspherically concave, or have any other desired curvature. A curved display system of this type may be used with any optical system 20. In other words, the curved display system may be used with any of the aforementioned embodiments.

In accordance with an embodiment, an electronic device is provided that includes a display panel configured to produce light for images and a lens module that receives the light from the display panel, the lens module includes first and second lens elements, a partially reflective mirror that is interposed between the first lens element and the display panel and a circular reflective polarizer that is coated on a surface of the first lens element, the circular reflective polarizer is interposed between the first and second lens elements and the circular reflective polarizer is in direct contact with the first lens element.

In accordance with another embodiment, the lens module includes a clean-up polarizer that is interposed between the second lens element and the circular reflective polarizer.

In accordance with another embodiment, the clean-up polarizer is coated on the circular reflective polarizer.

In accordance with another embodiment, the lens module includes a layer of optically clear adhesive that attaches the clean-up polarizer to the circular reflective polarizer.

In accordance with another embodiment, the circular reflective polarizer includes a cholesteric liquid crystal layer.

In accordance with another embodiment, the lens module includes a layer of optically clear adhesive that is attached to the second lens element.

In accordance with another embodiment, the circular reflective polarizer provides optical power to the lens module.

In accordance with another embodiment, the circular reflective polarizer includes a cholesteric liquid crystal layer that is formed over a patterned alignment layer.

In accordance with another embodiment, the circular reflective polarizer includes a liquid crystal geometric phase layer.

In accordance with another embodiment, the first lens element includes an embedded air-filled gap.

In accordance with another embodiment, the first lens element includes a solid material with an embedded gap and a filler material in the embedded gap and the filler material has a different refractive index than the solid material.

In accordance with another embodiment, the first lens element includes an embedded gap and the circular reflective polarizer is formed in the embedded gap.

In accordance with another embodiment, the lens module includes an anti-reflective coating on the second lens element, the second lens element is interposed between the anti-reflective coating and the circular reflective polarizer.

In accordance with another embodiment, the display panel is curved.

In accordance with an embodiment, a head-mounted display configured to display images is provided that includes a display panel configured to produce light for the images and a lens module that receives the light from the display panel, the lens module includes first, second, and third lens elements, a partially reflective mirror that is interposed between the first and second lens elements, a quarter wave plate that is coated on a surface of the second lens element, and a reflective polarizer that is formed between the third lens element and the quarter wave plate.

In accordance with another embodiment, the lens module includes a linear polarizer that is formed between the third lens element and the reflective polarizer.

In accordance with another embodiment, the lens module includes a layer of optically clear adhesive that attaches the linear polarizer to the reflective polarizer.

In accordance with another embodiment, the first lens element has first and second opposing surfaces, the second lens element has first and second opposing surfaces, and the partially reflective mirror conforms to the second surface of the first lens element and the first surface of the second lens element.

In accordance with another embodiment, the first lens element is attached directly to the display panel with a layer of optically clear adhesive.

In accordance with another embodiment, the first lens element has first and second opposing surfaces, the second lens element has first and second opposing surfaces, the partially reflective mirror conforms to the second surface of the first lens element, and an air gap is present between the partially reflective mirror and the first surface of the second lens element.

In accordance with another embodiment, the display panel has a cylindrically concave surface that faces the lens module.

In accordance with another embodiment, the display panel has a spherically concave surface that faces the lens module.

In accordance with an embodiment, a head-mounted display configured to display images viewable by a user is provided that includes a display panel configured to produce light for the images and a lens module that receives the light from the display panel, the lens module includes first and second lens elements, a partially reflective mirror that is interposed between the first lens element and the display panel, a quarter wave plate that is coated on a surface of the first lens element, a reflective polarizer that is formed between the second lens element and the quarter wave plate and a linear polarizer that is formed between the second lens element and the reflective polarizer, the linear polarizer is coated to the reflective polarizer.

In accordance with another embodiment, the first lens element has a refractive index gradient.

In accordance with an embodiment, a head-mounted display configured to display images viewable by a user, is provided that includes a display panel configured to produce light for the images and a lens module that receives the light from the display panel, the lens module includes first and second lens elements, the first lens element has an embedded gap, a partially reflective mirror that is interposed between the first lens element and the display panel, a quarter wave plate that formed in the embedded gap in the first lens element, a reflective polarizer that is formed between the second lens element and the first lens element and a linear polarizer that is formed between the second lens element and the reflective polarizer.

The foregoing is merely illustrative and various modifications can be made to the described embodiments. The foregoing embodiments may be implemented individually or in any combination.

What is claimed is:

1. An electronic device, comprising:
a display panel configured to produce light for images; and
a lens module that receives the light from the display panel, wherein the lens module comprises:
first and second lens elements;
a partially reflective mirror that is interposed between the first lens element and the display panel; and
a circular reflective polarizer that is coated on a surface of the first lens element, wherein the circular reflective polarizer is interposed between the first and second lens elements and wherein the circular reflective polarizer is in direct contact with the first lens element.

2. The electronic device defined in claim 1, wherein the lens module further comprises:
a clean-up polarizer that is interposed between the second lens element and the circular reflective polarizer.

3. The electronic device defined in claim 2, wherein the clean-up polarizer is coated on the circular reflective polarizer.

4. The electronic device defined in claim 2, wherein the lens module further comprises:
a layer of optically clear adhesive that attaches the clean-up polarizer to the circular reflective polarizer.

5. The electronic device defined in claim 1, wherein the circular reflective polarizer comprises a cholesteric liquid crystal layer.

6. The electronic device defined in claim 1, wherein the lens module further comprises:
a layer of optically clear adhesive that is attached to the second lens element.

7. The electronic device defined in claim 1, wherein the circular reflective polarizer provides optical power to the lens module.

8. The electronic device defined in claim 7, wherein the circular reflective polarizer comprises a cholesteric liquid crystal layer that is formed over a patterned alignment layer.

9. The electronic device defined in claim 7, wherein the circular reflective polarizer comprises a liquid crystal geometric phase layer.

10. The electronic device defined in claim 1, wherein the first lens element includes an embedded air-filled gap.

11. The electronic device defined in claim 1, wherein the first lens element includes a solid material with an embedded gap and a filler material in the embedded gap and wherein the filler material has a different refractive index than the solid material.

12. The electronic device defined in claim 1, wherein the first lens element includes an embedded gap and wherein the circular reflective polarizer is formed in the embedded gap.

13. The electronic device defined in claim 1, wherein the lens module further comprises:
an anti-reflective coating on the second lens element, wherein the second lens element is interposed between the anti-reflective coating and the circular reflective polarizer.

14. The electronic device defined in claim 1, wherein the display panel is curved.

15. A head-mounted display configured to display images, comprising:
a display panel configured to produce light for the images; and
a lens module that receives the light from the display panel, wherein the lens module comprises:
first, second, and third lens elements;
a partially reflective mirror that is interposed between the first and second lens elements;
a quarter wave plate that is coated on a surface of the second lens element; and
a reflective polarizer that is formed between the third lens element and the quarter wave plate.

16. The head-mounted display defined in claim 15, wherein the lens module further comprises:
a linear polarizer that is formed between the third lens element and the reflective polarizer.

17. The head-mounted display defined in claim 16, wherein the lens module further comprises:
a layer of optically clear adhesive that attaches the linear polarizer to the reflective polarizer.

18. The head-mounted device defined in claim 15, wherein the first lens element has first and second opposing surfaces, wherein the second lens element has first and second opposing surfaces, and wherein the partially reflective mirror conforms to the second surface of the first lens element and the first surface of the second lens element.

19. The head-mounted device defined in claim 15, wherein the first lens element is attached directly to the display panel with a layer of optically clear adhesive.

20. The head-mounted device defined in claim 15, wherein the first lens element has first and second opposing surfaces, wherein the second lens element has first and second opposing surfaces, wherein the partially reflective mirror conforms to the second surface of the first lens element, and wherein an air gap is present between the partially reflective mirror and the first surface of the second lens element.

21. The head-mounted device defined in claim 15, wherein the display panel has a cylindrically concave surface that faces the lens module.

22. The head-mounted device defined in claim 15, wherein the display panel has a spherically concave surface that faces the lens module.

23. A head-mounted display configured to display images viewable by a user, comprising:
a display panel configured to produce light for the images; and
a lens module that receives the light from the display panel, wherein the lens module comprises:
first and second lens elements;
a partially reflective mirror that is interposed between the first lens element and the display panel;
a quarter wave plate that is coated on a surface of the first lens element;
a reflective polarizer that is formed between the second lens element and the quarter wave plate; and
a linear polarizer that is formed between the second lens element and the reflective polarizer, wherein the linear polarizer is coated to the reflective polarizer.

24. The head-mounted display defined in claim 23, wherein the first lens element has a refractive index gradient.

25. A head-mounted display configured to display images viewable by a user, comprising:
a display panel configured to produce light for the images; and
a lens module that receives the light from the display panel, wherein the lens module comprises:
first and second lens elements, wherein the first lens element has an embedded gap;
a partially reflective mirror that is interposed between the first lens element and the display panel;
a quarter wave plate that formed in the embedded gap in the first lens element;
a reflective polarizer that is formed between the second lens element and the first lens element; and
a linear polarizer that is formed between the second lens element and the reflective polarizer.
